(19) United States
(12) Patent Application Publication
(10) Pub. No.: US 2026/0328157 A1
(43) Pub. Date: Oct. 22, 2026

(54) INTERNAL COMBUSTION ENGINES AND CYLINDER HEADS FOR GENERATING TUMBLE FLOW

(71) Applicant: Cummins Inc., Columbus, IN (US)

(72) Inventors: Robert G. Sperry, Columbus, IN (US); Eric R. Downey, Columbus, IN (US); David M. Barnes, Columbus, IN (US); Jason Robert Griffin, Greenwood, IN (US)

(21) Appl. No.: 19/467,035

(22) Filed: Feb. 2, 2026

Related U.S. Application Data
(60) Provisional application No. 63/756,971, filed on Feb. 11, 2025.

(51) Int. Cl. F02F 1/42

(52) U.S. Cl. CPC F02F 1/4235

(57) ABSTRACT

An internal combustion engine includes a cylinder head configured to generate tumble in a charge flow introduced into a combustion chamber. The cylinder head includes at least one port for receiving at least a portion of the charge flow and provide received port of the charge flow to a combustion chamber of the internal combustion engine. The cylinder head includes a tumble passage connecting an upstream portion of the at least one port to a downstream portion of the at least one port.

### CROSS-REFERENCE TO RELATED APPLICATION:

The present application claims the benefit of the filing date of, and priority to, U.S. Provisional Application Ser. No. 63/756,971 filed on Feb. 11, 2025, which is incorporated herein by reference.

### TECHNICAL FIELD

This invention relates to internal combustion engines and, more particularly, to cylinder heads configured to induce tumble in the charge flow introduced in combustion chambers of internal combustion engines.

### BACKGROUND

A cylinder head for an internal combustion engine may include two intake valve openings into the combustion chamber that are opened and closed by respective first and second intake valves. The valve openings are connected to respective ones of first and second intake ports that distribute the charge flow from the intake manifold to the respective intake valve openings.

Tumble of the charge flow in the combustion chamber is desirable to aid in mixing with fuel and to improve combustion stability, increase the burn rate of fuel, and reduce knock tendency. Ideally, tumble is designed into the port system without further modification of the cylinder head. Port design changes can be costly if new desired tumble magnitude is desired. In some instances one or more of the intake ports may be modified with partitions, valves, and other structures to change the tumble magnitude. However, such tumble inducing modifications can require additional components to be installed in the intake ports and/or changes to the geometry of the intake port to induce tumble flow, which results in increased development and production costs. Therefore, further improvements in this technological area are desired.

### SUMMARY

Systems and devices are disclosed herein relating to an internal combustion engine and cylinder heads. The cylinder heads are configured to generate a specific or desired magnitude of tumble of the charge flow introduced into combustion chambers of the internal combustion engine through the intake ports of the cylinder head.

In an embodiment, an internal combustion engine includes at least one cylinder including a combustion chamber. A cylinder head is configured to provide a charge flow to the combustion chamber. The cylinder head includes at least one port connected to an outlet of the at least one port. The at least one port is configured to introduce charge flow into the combustion chamber through the outlet. The cylinder head also includes a tumble passage fluidly connecting an upstream portion of the at least one port to a downstream portion of the at least one port. The tumble passage is configured to divert a portion of the charge flow from the upstream portion and re-introduce the diverted portion of the charge flow into the downstream portion to generate a tumble in the charge flow introduced into the combustion chamber through the outlet of the at least one port.

In an embodiment, a cylinder head for distributing a charge flow to an internal combustion engine in provided. The cylinder head includes at least one port for receiving at least a portion of the charge flow. The at least one port is configured to provide the received portion of the charge flow to a combustion chamber of the internal combustion engine. The at least one port includes an upstream portion and a downstream portion. The cylinder head also includes a tumble passage fluidly connecting the upstream portion of the at least one port to the downstream portion of the at least one port. The tumble passage is configured to divert a part of the received portion of the charge flow from the upstream portion and re-introduce the diverted portion of the charge flow to the downstream portion upstream to induce tumble motion in the charge flow in the combustion chamber.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic diagram of an internal combustion engine according to one embodiment of the present disclosure.

FIG. 2 is a section view through a cylinder of the internal combustion engine of

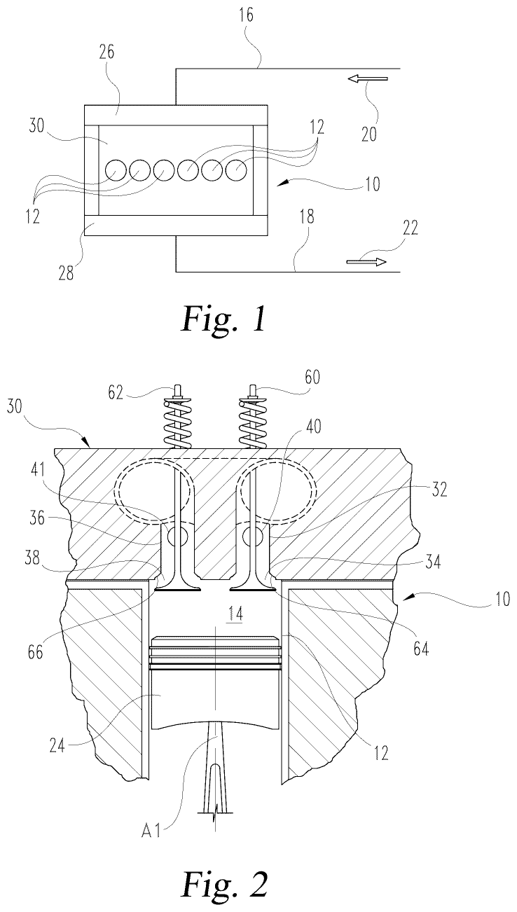

FIG. 1 showing an intake port arrangement in the cylinder head according to an embodiment of the present disclosure.

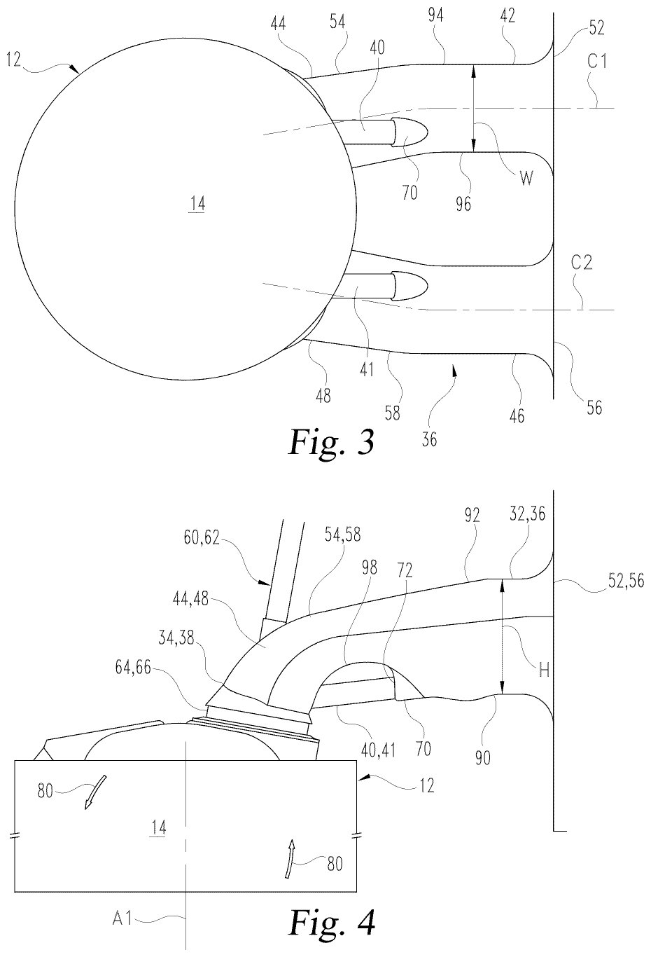

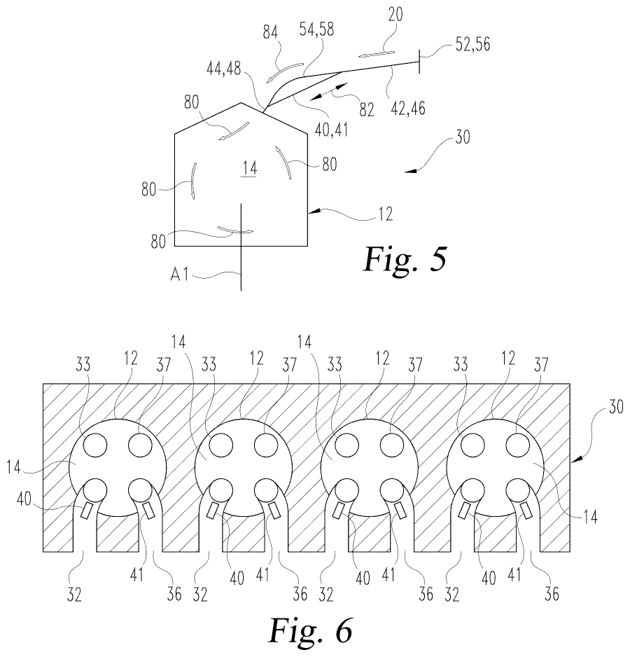

FIG. 3 is a plan view of the intake port arrangement of FIG. 2.

FIG. 4 is an elevation view of the intake port arrangement of FIG. 2.

FIG. 5 is a schematic diagram of the intake port arrangement of FIG. 3.

FIG. 6 is a schematic diagram showing a cylinder port configuration in the cylinder head according to an embodiment of the present disclosure.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

FIGS. 1-6 show various aspects of an internal combustion engine 10. Internal combustion engine 10 includes at least one cylinder 12 and a cylinder head 30. Cylinder head 30 includes a combustion chamber 14. Cylinder head 30 is configured to provide a charge flow 20 to the combustion chamber 14. Cylinder head 30 includes at least one port 32 connected to an outlet 34 of the at least one port 32. The at least one port 32 is configured to introduce charge flow 20 into combustion chamber 14 through outlet 34. Cylinder head 30 also includes a tumble passage 40 fluidly connecting an upstream portion 42 of the at least one port 32 to a downstream portion 44 of the at least one port 32. Tumble passage 40 is configured to divert a portion of charge flow 20 from upstream portion 42 and re-introduce the diverted portion of charge flow 20 into downstream portion 44 to generate a tumble in charge flow 20 introduced into combustion chamber 14 through outlet 34.

Also disclosed is cylinder head 30 for distributing charge flow 20 within internal combustion engine 10. Cylinder head 30 includes at least one port 32 for receiving at least a portion of charge flow 20. The at least one port 32 is configured to provide the received portion of charge flow 20 to combustion chamber 14 of internal combustion engine 10. The at least one port 32 includes upstream portion 42 and downstream portion 44. Cylinder head 30 also includes tumble passage 40 fluidly connecting upstream portion 42 of the at least one port 32 to downstream portion 44 of the at least one port 32. Tumble passage 40 is configured to divert a part of the received portion of charge flow 20 from upstream portion 42 and re-introduce the diverted portion of charge flow 20 to downstream portion 44 to induce tumble motion in charge flow 20 in combustion chamber 14.

Referring to FIGS. 1-2, internal combustion engine 10 includes a plurality of cylinders 12. Each of the cylinders 12 includes a combustion chamber 14. Internal combustion engine 10 also includes an intake 16 and an exhaust 18 connected to each combustion chamber 14 of cylinders 12. Intake 16 provides charge flow 20 to combustion chambers 14, and exhaust 18 provides a path for exhaust flow 22 to be expelled from combustion chambers 14.

Engine 10 further includes cylinder head 30 that extends along one or more of the cylinders 12. Intake 16 includes an intake manifold 26 connected to cylinder head 30. Intake manifold 26 distributes charge flow 20 to the combustion chambers 14 through a plurality of intake ports of cylinder head 30, as discussed further below. An exhaust manifold 28 collects the exhaust output from combustion in the combustion chambers 14 of each of the cylinders 12 and provides the exhaust flow 22 to exhaust 18.

Engine 10 can be any type of engine, and in one specific embodiment is a combustion engine that combusts any suitable fuel and includes a number of cylinders 12 each housing a piston 24. Piston 24 reciprocates between top-dead-center and bottom-dead-center positions in cylinder 12 along a vertical axis A1 of the cylinder 12. In the illustrated embodiment, engine 10 includes four cylinders connected with intake manifold 26 and exhaust manifold 28 via cylinder head 30. However, any number of cylinders 12 capable of being used for an engine 10 is contemplated. Engine 10 can be an in-line type engine with a single cylinder bank as shown in the illustrated embodiment, or other configuration including V-shaped cylinder arrangements, a W-type engine, or any engine arrangement with one or more cylinders 12. It is contemplated that engine 10 is provided as part of a powertrain for a vehicle (not shown), although other applications are also contemplated and not precluded, such as for gensets and marine applications.

Referring further to FIGS. 3-5, each of the first ports 32 includes a respective first outlet 34, and each of the second ports 36 includes a respective second outlet 38. The first outlets 34 and second outlets 38 admit charge flow 20 into the combustion chamber 14 of the corresponding cylinder 12 when intake valves 60, 62 are lifted from their respective valve seats 64, 66. For example, each cylinder 12 includes two intake valves 60, 62 that are opened and closed by a valve opening mechanism (not shown) via a camshaft (not shown.) The opening of the valve(s) 60, 62 allows charge flow 20 to be admitted into the combustion chamber 14 of the respective cylinder 12 through outlets 34, 38.

First port 32 includes upstream portion 42 extending from a first inlet 52, and a downstream portion 44 extending from first outlet 34. Upstream portion 42 is connected to downstream portion 44 with a connection portion 54 that forms a bend so that the first outlet 34 lies in a plane that is transversely oriented to a plane in which first inlet 52 lies. Second port 36 includes an upstream portion 46 extending from a second inlet 56, and a downstream portion 48 extending from second outlet 38. Upstream portion 46 is connected to downstream portion 48 with a second connection portion 58 that forms a bend so that the second outlet 38 lies in a plane that is transversely oriented to a plane in which second inlet 56 lies.

Tumble passage 40 connects the higher pressure upstream portion 42 of first port 32 to a lower pressure downstream portion 44 of first port 32. Similarly, tumble passage 41 connects the higher pressure upstream portion 46 of second port 36 to a lower pressure downstream portion 48 of second port 36. Tumble passages 40, 41 are connected to the downstream portions 44, 48 upstream of the respective valve seats 64, 66. However, embodiments are also contemplated in which only one of the first and second ports 32, 36 includes a tumble passage.

In an embodiment, each of tumble passages 40, 41 is circular in cross-section along all or a portion of a length thereof. However, non-circular cross-sections are also contemplated. For example, in an embodiment, tumble passages 40, 41 have cross-sections that are oval, elliptical, polygonal, or other non-circular shape or configuration along all or a portion of a length thereof.

A part 82 of the charge flow 20 is passively diverted from upstream portions 42, 46 into the respective tumble passage 40, 41, and the remaining part 84 of charge flow 20 travels through connection portion 54, 58. No valve or other opening and closing structure is required for charge flow to enter tumble passages 40, 41, but the provision of a flow control valve to control flow through one or both of tumble passages 40, 41 is not precluded.

The diverted part 82 of charge flow 20 travels from the upstream portion 42, 46 to the connected downstream portion 44, 48 and bypasses connection portion 54, 58. The diverted part 82 of the charge flow 20 exiting tumble passage 40, 41 induces a tumble motion 80 in the charge flow 20 that is admitted into the combustion chamber 14 through the corresponding one of the first and second outlets 34, 38. As used herein, tumble motion 80 is motion of the charge flow within combustion chamber 14 that occurs around an axis that is perpendicular or otherwise transverse to the vertical axis A1 of the cylinder 12.

Tumble passages 40, 41 can be configured during the casting process to provide a desired tumble number or magnitude of tumble motion 80 for the charge flow 20 in combustion chamber 14. It is further contemplated that the tumble number or magnitude of tumble can be modified after casting tumbles passages 40, 41 by testing or modeling tumble motion 80, 81 and then machining features upstream of, downstream of, and/or along tumble passages 40, 41 to increase tumble.

In an embodiment, first and second outlets 34, 38 lie in a common plane, and first and second inlets 52, 56 lie in a common plane. In an embodiment, first and second outlets 34, 38 lie in a plane that is obliquely oriented to the plane in which first and second inlets 52, 56 lie. Other embodiments contemplate other configuration and orientations between the inlets and outlets of the first and second ports 32, 36. For example, first and second outlets 34, 38 may lie in a plane that is orthogonal to, or parallel to, the plane in which first and second inlets 52, 56 lie. In still other embodiments, first and second inlets 52, 56 and/or first and second outlets 34, 38 are not co-planar.

In an embodiment, first port 32 and second port 36 are shaped identically to one another. Therefore, the discussion that follows regarding the shape of first port 32 also applies to second port 36, although non-identical shapes between first and second ports 32, 36 are also contemplated. In addition, tumble passages 40, 41 can be identical in shape, but non-identical shapes between tumbles passages 40, 41 of adjacent first and second ports 32, 36 is also contemplated, including omission of a tumble passage on one of the first and second ports 32, 36.

First port 32 includes a first side 90 oriented toward combustion chamber 14 and a second side 92 opposite first side 90. Second side 92 is oriented away from the combustion chamber 14. Opposite latera sides 94, 96 extend between and connect first and second sides 90, 92 to one another. Opposite lateral sides 94, 96 define a width W therebetween, and first and second sides 90, 92 define a height H therebetween.

First side 90 includes a concave part 98 that extends along connection portion 54 and connects upstream portion 42 to downstream portion 44. Tumble passage 40 extends along first side 90 of first port 32 and spans concave part 98. In an embodiment, tumble passage 40 is separated from and extends along connection portion 54 between the upstream and downstream portions 42, 44. In an embodiment, tumble passage 40 is linear and spans the bend formed by concave part 98 of connection portion 54 to fluidly connect upstream portion 42 to downstream portion 44 of first port 32.

First port 32 has a first centerline C1 and second port 36 as a second centerline C2. In an embodiment, centerlines C1, C2 are curved and converge in a direction toward combustion chamber 14, as shown in FIG. 3. First port 32 and second port 36 also have a cross-sectional shape and size orthogonal to the respective centerlines C1 and C2. Tumble passages 40, 41 also each have a cross-section that is smaller than the cross-section of the adjacent connection portion 54, 58. Therefore, the quantity of charge flow 20 diverted by the tumble passages 40, 41 is smaller than the quantify of charge flow passing through connection portions 54, 58.

In an embodiment, the upstream end of tumble passage 40 non-centered relative to width W and/or is offset from centerline C1 toward second lateral side 96 at upstream portion 42. The downstream end of tumble passage 40 at downstream portion 44 is more closely centered on width W and/or more closely aligned with, or aligned on, centerline C1. Tumble passage 41 can be similarly arranged on second port 36 such that tumble passages 40, 41 extend parallel to one another. This configuration allows charge flow to be diverted from an off-center location at upstream portion 42, 46 to minimize disruption of the charge flow and re-introduced at a more central location at downstream portion 44, 48 to enhance inducing tumble.

In an embodiment, first port 32 includes a boss 70 in fluid communication with upstream portion 42. Boss 70 projects from upstream portion 42 at or near the connection of concave part 98 to first side 90. Boss 70 extends toward downstream portion 44 along the concave part 98 of first port 32. Tumble passage 40 forms an extension from boss 70 to downstream portion 44. In an embodiment, boss 70 is cylindrical and includes a planar end face 72. Tumble passage 40 extends from planar end face 72 of boss 70 to downstream portion 44. Second port 36 can includes a similarly configured boss arrangement.

In an embodiment, first port 32 is curved from first inlet 52 toward first outlet 34 and combustion chamber 14. Second port 36 also curves from second inlet 56 toward second outlet 38 and combustion chamber 14. In addition or alternatively, first port 32 and second port 36 converge toward one another in a direction toward combustion chamber 14. Other embodiments contemplate non-curved and/or non-converging configurations for first and second ports 32, 36.

In an embodiment, tumble passage 40, 41 is uniform in size from upstream portion 42, 46 to downstream portion 44, 48. In an embodiment, each tumble passage 40, 41 includes a circular cross-section along its length. Other embodiments contemplate non-circular and/or tapered tumble passages 40, 41. In still other embodiments, tumble passages 40, 41 are shaped differently from one another to produce different tumble effects. In an embodiment, tumble passages 40, 41 are inclined from their connection with the respective upstream portions 42, 46 to their respective connections with the downstream portions 44, 48 in a direction toward combustion chamber 14.

Referring further to FIG. 6, there is illustrated further details of cylinder head 30 according to an embodiment of the present disclosure. In the illustrated embodiment, cylinder head 30 is a unitary body with a plurality of first ports 32, each paired with a corresponding one of a plurality of second ports 36. The paired first and second ports 32, 36 are flow connected to respective ones of the plurality of cylinders 12 to provide charge flow 20 to combustion chambers 14. In addition, each pair of first and second ports 32, 36 includes tumble passages 40, 41 configured to induce tumble in the charge flow delivered to the corresponding combustion chamber 14 connected thereto.

First port 32, second port 36, and/or tumble passages 40, 41 may be formed by casting, drilling, machining, or other forming technique in the cylinder head 30. Cylinder head 30 can be comprised of a single, unitary body sized to extend along all cylinders 12 of engine 10, or divided into two or more parts that span one or more cylinders 12. In addition, cylinder head 30 can include other features not shown in the illustrated embodiments, such as passages, drillings, and other ports for injectors, sensors, fasteners, and the like.

Various intake and exhaust port configurations at the interface with cylinders 12 are also contemplated. For example, the intake ports 32, 36 and the exhaust ports 33, 37 of each cylinder 12 can be arranged so that the openings into each combustion chamber 14 are arranged in a square pattern such as shown in FIG. 6, or in a diamond pattern or other pattern.

Many aspects of the present disclosure are envisioned. For example, one aspect is directed to an internal combustion engine including at least one cylinder including a combustion chamber and a cylinder head configured to provide a charge flow to the combustion chamber. The cylinder head includes at least one port connected to an outlet of the at least one port. The at least one port is configured to introduce charge flow into the combustion chamber through the outlet. The cylinder head also includes a tumble passage fluidly connecting an upstream portion of the at least one port to a downstream portion of the at least one port. The tumble passage is configured to divert a portion of the charge flow from the upstream portion and re-introduce the diverted portion of the charge flow into the downstream portion to generate a tumble in the charge flow introduced into the combustion chamber through the outlet.

In an embodiment, the cylinder head includes a second port adjacent to the at least one port. The second port is connected to a second outlet of the second port. The second port is configured to introduce charge flow into the combustion chamber through the second outlet.

In a further embodiment, the cylinder head includes a second tumble passage connecting an upstream portion of the second port to a downstream portion of the second port, the second tumble passage being configured to generate a tumble in the charge flow introduced into the combustion chamber through the second outlet with a portion of the charge flow diverted from the second port through the second tumble passage.

In a further embodiment, the at least one port and the second port converge toward one another from the upstream portion toward the downstream portions thereof, and the tumble passages are parallel to one another.

In an embodiment, the outlet includes a valve seat engageable by an intake valve to close the at least one port. The downstream location is upstream of the outlet and the valve seat in the at least one port.

In an embodiment, the tumble passage includes a uniform diameter from the upstream portion to the downstream portion.

In an embodiment, the upstream portion of the at least one port is a higher pressure region than the downstream portion of the at least one port. The portion of the charge flow is passively diverted from the upstream portion into the tumble passage.

In an embodiment, the at least one port includes a connection portion that fluidly connects the upstream portion to the downstream portion. The tumble passage is separate from and bypasses the connection portion.

In a further embodiment, the at least one port includes a concave part and the tumble passage spans the concave part between the upstream portion and the downstream portion.

According to another aspect of the present disclosure, a cylinder head for distributing a charge flow within an internal combustion engine is provided. The cylinder head includes at least one port for receiving at least a portion of the charge flow. The at least one port is configured to provide the received portion of the charge flow to a combustion chamber of the internal combustion engine. The at least one port includes an upstream portion and a downstream portion. The cylinder head also includes a tumble passage fluidly connecting the upstream portion of the at least one port to the downstream portion of the at least one port. The tumble passage is configured to divert a part of the received portion of the charge flow from the upstream portion and re-introduce the diverted portion of the charge flow to the downstream portion to induce tumble motion in the charge flow in/the combustion chamber.

In an embodiment, the at least one port includes a plurality of first ports associated with a plurality of combustion chambers and a plurality of second ports associated with the plurality of combustion chambers. Each of the plurality of first ports is paired with a respective one of the plurality of second port at each of the plurality of combustion chambers.

In a further embodiment, each of the plurality of first ports and each of the plurality of second ports includes a tumble passage connecting an upstream portion thereof to a downstream portion thereof.

In an embodiment, the at least one port includes a first side oriented toward the combustion chamber and a second side opposite the first side. The second side is oriented away from the combustion chamber. The tumble passage extends along the first side of the at least one port.

In a further embodiment, the at least one port includes a connection portion that fluidly connects the upstream portion to the downstream portion. The tumble passage is separated from and extends along the connection portion.

In a further embodiment, the connection portion forms a bend in the at least one port. The tumble passage is linear and spans the bend from the upstream portion to the downstream portion of the at least one port.

In a further embodiment, the connection portion includes a first cross-section. The tumble passage includes a second cross-section that is smaller than the first cross-section.

In an embodiment, the at least one port has opposite sides separated by a width. The width extends from the upstream portion to the downstream portion. The tumble passage is offset toward one of the opposite sides at the upstream portion and is centered between the opposite sides at the downstream portion.

In an embodiment, the at least one port includes a concave part extending between the upstream portion and the downstream portion. The tumble passage extends along the concave part of the at least one port.

In a further embodiment, the at least one port includes a boss in fluid communication with the upstream portion. The boss projects from the upstream portion toward the downstream portion along the concave part of the at least one port. The tumble passage extends from the boss to the downstream portion.

In a further embodiment, the boss is cylindrical and includes a planar end face. The tumble passage extends from the planar end face to the downstream portion

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An internal combustion engine, the internal combustion engine comprising:
at least one cylinder including a combustion chamber; and
a cylinder head configured to provide a charge flow to the combustion chamber, the cylinder head including:
at least one port connected to an outlet of the at least one port, the at least one port being configured to introduce the charge flow into the combustion chamber through the outlet;
a tumble passage fluidly connecting an upstream portion of the at least one port to a downstream portion of the at least one port, the tumble passage being configured to divert a portion of the charge flow from the upstream portion and re-introduce the diverted portion of the charge flow into the downstream portion to generate a tumble in the charge flow introduced into the combustion chamber through the outlet of the at least one port.

2. The internal combustion engine of claim 1, wherein the cylinder head includes:
a second port adjacent to the at least one port, wherein the second port is connected to a second outlet of the second port; and
the second port is configured to introduce charge flow into the combustion chamber through the second outlet.

3. The internal combustion engine of claim 2, wherein the cylinder head includes a second tumble passage connecting an upstream portion of the second port to a downstream portion of the second port, the second tumble passage being configured to generate a tumble in the charge flow introduced into the combustion chamber through the second outlet of the second port with a portion of the charge flow diverted from the second port through the second tumble passage.

4. The internal combustion engine of claim 3, wherein:
the at least one port and the second port converge toward one another from the upstream portion toward the downstream portions thereof; and
the tumble passages are parallel to one another.

5. The internal combustion engine of claim 1, wherein:
the outlet includes a valve seat engageable by an intake valve to close the at least one port; and
the downstream portion is upstream of the outlet and the valve seat in the at least one port.

6. The internal combustion engine of claim 1, wherein the tumble passage includes a uniform diameter from the upstream portion to the downstream portion.

7. The internal combustion engine of claim 1, wherein:
the upstream portion of the at least one port is a higher pressure region than the downstream portion of the at least one port; and
the portion of the charge flow is passively diverted from the upstream portion into the tumble passage.

8. The internal combustion engine of claim 1, wherein:
the at least one port includes a connection portion that fluidly connects the upstream portion to the downstream portion; and
the tumble passage is separate from and bypasses the connection portion.

9. The internal combustion engine of claim 8, wherein the at least one port includes a concave part oriented toward the combustion chamber and the tumble passage spans the concave part.

10. A cylinder head for distributing a charge flow within an internal combustion engine, the cylinder head comprising:
at least one port for receiving at least a portion of the charge flow, the at least one port being configured to provide the received portion of the charge flow to a combustion chamber of the internal combustion engine, the at least one port including an upstream portion and a downstream portion; and
a tumble passage fluidly connecting the upstream portion of the at least one port to the downstream portion of the at least one port, the tumble passage being configured to divert a part of the received portion of the charge flow from the upstream portion and re-introduce the diverted portion of the charge flow to the downstream portion to induce tumble motion in the charge flow in/the combustion chamber.

11. The cylinder head of claim 10, wherein the at least one port includes:
a plurality of first ports associated with a plurality of combustion chambers; and
a plurality of second ports associated with the plurality of combustion chambers, wherein each of the plurality of first ports is paired with a respective one of the plurality of second port at each of the plurality of combustion chambers.

12. The cylinder head of claim 11, wherein each of the plurality of first ports and each of the plurality of second ports includes a tumble passage connecting an upstream portion thereof to a downstream portion thereof.

13. The cylinder head of claim 10, wherein:
the at least one port includes a first side oriented toward the combustion chamber and a second side opposite the first side, the second side oriented away from the combustion chamber; and
the tumble passage extends along the first side of the at least one port.

14. The cylinder head of claim 13, wherein:
the at least one port includes a connection portion that fluidly connects the upstream portion to the downstream portion; and
the tumble passage is separated from and extends along the connection portion.

15. The cylinder head of claim 14, wherein:
the connection portion forms a bend in the at least one port; and
the tumble passage is linear and spans the bend from the upstream portion to the downstream portion of the at least one port.

16. The cylinder head of claim 14, wherein:
the connection portion includes a first cross-section; and
the tumble passage includes a second cross-section that is smaller than the first cross-section.

17. The cylinder head of claim 10, wherein:
the at least one port has opposite sides separated by a width, the width extending from the upstream portion to the downstream portion; and
the tumble passage is offset toward one of the opposite sides at the upstream portion and is centered between the opposite sides at the downstream portion.

18. The cylinder head of claim 10, wherein:
the at least one port includes a concave part extending between the upstream portion and the downstream portion; and
the tumble passage extends along the concave part of the at least one port.

19. The cylinder head of claim 18, wherein:
the at least one port includes a boss in fluid communication with the upstream portion, the boss projecting from the upstream portion toward the downstream portion along the concave part of the at least one port; and
the tumble passage extends from the boss to the downstream portion.

20. The cylinder head of claim 19, wherein:
the boss is cylindrical and includes a planar end face; and
the tumble passage extends from the planar end face to the downstream portion.
